(19) United States
(12) Patent Application Publication
(10) Pub. No.: US 2015/0222691 A1
(43) Pub. Date: Aug. 6, 2015

(54) Hub Application Automation Widget

(71) Applicant: Google Inc., Mountain View, CA (US)

(72) Inventors: Lei Zhang, Foster City, CA (US); Joe Onorato, Cambridge, MA (US)

(73) Assignee: Google Inc., Mountain View, CA (US)

(21) Appl. No.: 14/174,544

(22) Filed: Feb. 6, 2014

(51) Int. Cl. H04L 29/08; G06F 3/0482; G06F 3/0484

(52) U.S. Cl. CPC H04L 67/025; G06F 3/04842; G06F 3/0482

(57) ABSTRACT

Systems and techniques are disclosed for detecting the presence of a physical device and receiving a widget associated with the physical device. The widget may identify a template to be bound with such that the template may be a hub application approved template that the widget may bind with when compiling. The compiled widget (using the template) may result in an interface presented to a user via the hub application such that the hub application may control multiple physical devices.

### BACKGROUND

Traditional products that can be controlled via a user device generally have a standalone user interface such as a website or an application that communicates with the product. As an example, a traditional speaker system that is capable of being controlled by a user's mobile phone may have a corresponding application that is installed on the user's mobile phone. The application may be accessed by a user via the mobile phone and the user may control the speakers via a user interface corresponding to the application. However, a user may be required to install multiple applications that correspond to multiple products, cluttering up the user's user device.

### BRIEF SUMMARY

According to implementations of the disclosed subject matter, the presence of a physical device may be detected and communication with the physical device may be established. A device identification corresponding to the detected first physical device may be extracted. A widget associated with the detected physical device may be received based on the extracted device identification and the widget may contain template information. A template may be received based on the template information such that values from the template may be bound with the widget and the widget may be compiled and rendered based on the bound values. The widget may be rendered in a hub application that contains control interfaces for multiple physical devices.

Systems and techniques according to the present disclosure multiple physical devices may be controlled via a hub application using widgets associated with the physical devices and templates that allow configuration of the hub application. Additional features, advantages, and implementations of the disclosed subject matter may be set forth or apparent from consideration of the following detailed description, drawings, and claims. Moreover, it is to be understood that both the foregoing summary and the following detailed description include examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIG. 3 shows an example process of receiving a template according to an implementation of the disclosed subject matter.

FIG. 4 shows an example visualization of communication between physical devise and one or more servers, according to an implementation of the disclosed subject matter.

FIG. 5 shows an example visualization of a hub application according to an implementation of the disclosed subject matter.

FIG. 6 shows an example visualization of physical device controls according to an implementation of the disclosed subject matter.

FIG. 7 shows an example visualization of components of the hub application and supplemental entities, according to an implementation of the disclosed subject matter.

FIG. 8 shows an example visualization of a rendered interface, according to an implementation of the disclosed subject matter.

### DETAILED DESCRIPTION

Traditionally, physical devices that are controlled via a user electronic device utilize a standalone application for each physical device. Alternatively or in addition, a manufacture of a physical device cannot customize a central application that controls multiple physical devices. Accordingly, a user may be required to switch between applications or may not be able to control physical devices as intended by the manufacturer due to lack of customization.

According to techniques disclosed herein, a hub application may be used to control multiple physical devices. For example, it may provide interfaces for a user to control lighting devices, televisions, media playback devices such as set-top boxes and game consoles, and/or other electronic devices. More generally, a physical device as disclosed herein may be any device configured to electronically communicate with a user device and may include lighting devices, entertainment devices, appliances, audio devices, video devices, media devices, securing devices (e.g., door locks, window controls, etc.), or the like. A physical device may communicate with a user device in any applicable manner such as a wired or wireless connection. A wireless connection may be established using any wireless medium such as Wi-Fi, Bluetooth™, radio frequency, infrared, near field communication, or the like. A physical device may be controlled by a hub application by receiving a widget associated with the physical device from a server (e.g., a third party manufacturer server, a server that stores widgets, etc.), which contains a pointer to a template such that the hub application interface is configured by compiling the widget using content contained in the template. The widget may enable a manufacturer to customize brand and product information for their products within a hub application while the hub application maintains a consistent look and feel for control of various physical devices. Additionally, a widget may extend existing hub applications to support new devices that are shipped independent of a hub application's release cycle. Thus, techniques and systems disclosed herein may allow for control of multiple disparate devices, without requiring the user to identify, install, learn, or otherwise interact with entirely separate applications or user interfaces for each device.

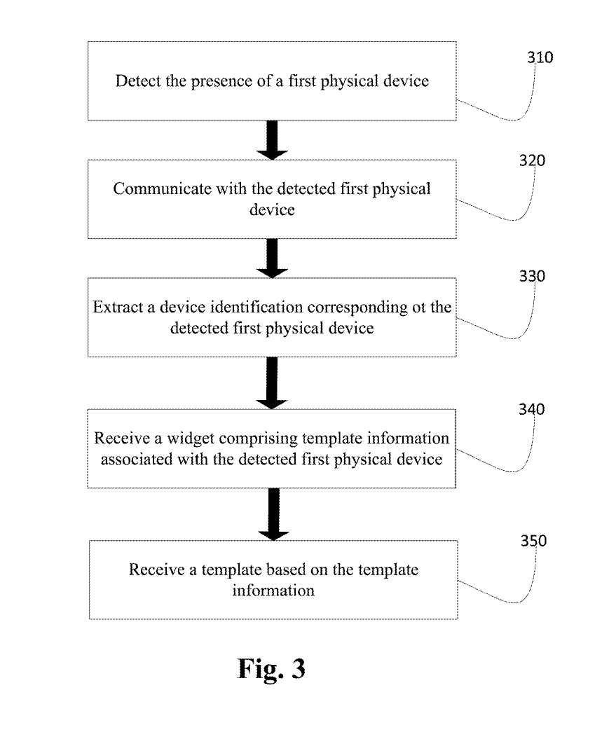

As shown in FIG. 3, at step 310 the presence of a physical device may be detected using any applicable communication such as a wired or wireless connection, as disclosed herein. The detection may occur when the physical device is first powered on. At step 320, communication with the detected physical device may be established. As an example, a user may purchase a lamp and place the purchased lamp in the user's living room. The user may then power on the lamp by connecting it to power socket. Upon powering, the lamp may transmit a signal that can be received by a user device such as the user's mobile phone. At step 330, device information corresponding to the physical device may be obtained from a transmitted signal based on the communication with the physical device. Obtaining the information may include evaluating the transmitted signal to detect the device information such as model number, manufacturer/vendor ID, etc. The extraction may be a digital extraction conducted via a processor. The transmitted signal may enable the user device to recognize the physical device and initiate configuration of a hub application for control of the physical device. The hub application may be accessible by a user device and may be stored either directly on the user device or may be locate at a storage location (e.g., server, database, computer, etc.) accessible by the user device. The user device may be any applicable device configured to access the hub application such as a mobile device (e.g. mobile phone, tablet, laptop, etc.), a home automation network, appliance, or the like.

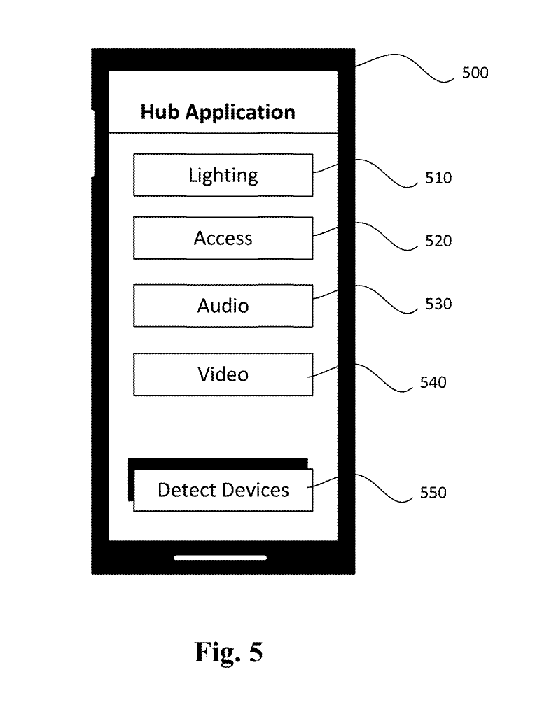

Alternatively, the hub application may transmit a request for physical devices, within communication range of a user device, to transmit a signal identifying the user devices. The hub application may then determine if there is a new physical device which has not previously been configured and, based on the determination, initiate configuration of the hub application for control of the newly detected physical device. As an illustrative example, as shown in FIG. 5, a hub application may be accessed via a user device 500. The hub application may contain controls for previously detected physical devices including a lighting 510, access 520, audio 530, and a video 540 device. Additionally, the hub application may contain a button to detect devices 550 such that, upon activation of the button 550, a signal is transmitted that requests physical devices within range of that signal to transmit a signal identifying themselves. The hub application may determine that a new physical device, for which the hub application is not currently configured, is available based on the transmitted signals, and may initiate configuration based on the determination. Alternatively, a periodic signal may automatically be transmitted and may request physical devices to transmit a signal identifying them. The hub application may determine that a new physical device, for which the hub application is not currently configured, is available based on the transmitted signals, and may initiate configuration based on the determination.

As shown at step 330, device information corresponding to a detected physical device may be extracted via the communication with the physical device. The device information may be any applicable information that enables identification of the physical device and/or software associated with the physical device and may include information such as a model number, vendor ID, device type, device version, or the like.

According to an implementation of the disclosed subject matter, a user device may communicate with a server or storage entity. The server or storage entity may be a third party manufacturer entity, a widget storage entity, or the like. At step 340, a widget containing template information associated with a corresponding physical device may be receive based on extracted device information. The extracted device identification may be used to either determine which server or storage entity to request a widget from, to enable a server or storage entity to extract a corresponding widget, or both. As an example, a user device may receive a lamp model number and vendor ID from a recently powered on lamp. The user device may identify a manufacturer server based on the vendor ID and communicate with the manufacturer server based on the identification. The user device may provide the lamp model number to the manufacturer server and the manufacturer server may identify a corresponding widget based on the lamp model number. More specifically, the manufacturer server may contain multiple widgets that may be associated with various products produced by the manufacturer. The user device may provide the manufacturer server with the lamp model number such that the manufacturer server can identify the widget corresponding to the lamp based on the lamp model number. Subsequently, the manufacturer server may provide the user device with the identified widget.

At step 350, a widget corresponding to a physical device and containing template information may be transmitted from the manufacturer server to a user device. The widget may enable a manufacturer to customize brand and product information for their products within a hub application while the hub application maintains a consistent look and feel for control of various physical devise. The template information may identify one or more templates that are required to compile the widget. The templates may be identified using template IDs that distinguish one template from another, and may contain any applicable interface or back end values such as icons, graphics, color schemes, images, buttons, or the like. The values may be static such as an icon to be displayed or a color to be shown to a user. Alternatively or in addition, a value may be dynamic. An example of a dynamic value may be a variable that is to be replaced by device name when a use is presented with the controls within the hub application. A dynamic value in a template may be bound with a widget at runtime and may define the type (e.g., device profile) that a compilation manager may use to deserialize a payload to extract runtime values. Notably, a upon receiving a template based on a template ID, a widget manager may instantiate a widget by binding the template received to either static (e.g., custom drawables) or dynamic values (e.g., runtime states like brightness or on-off state, etc.). Subsequently, the instantiated widget may be a portion of the user interface of a hub application that a user may interact with to control the physical device. As a specific example, the following code corresponds to a customized light widget with a logo:
<?xml version=“1.0” encoding=“utf-8”?>
<AtHomeWidget
   vendor=“ParentCompany”
   model=“L2”
   template=“@id/dimmable_light_template”
   >
   <bind id=“@id/light_icon” value=“@drawable/logo_company”/>
   <bind id=“@id/light_name” data_field=“name”/>
   <bind id=“@id/light_switch” facet=“405” property=“4” type=“1”/>
   <bind id=“@id/switch_onchange_listener” facet=“405” method=“2” type=“1”
/>
</AtHomeWidget>
   Here, the code within the widget identifies the vendor “ParentCompany” and model “L2”. Additionally, the code identifies the template ID “@id/dimmable_light_template” as well as binding parameters to be extracted from the template. As an example, the following code corresponds to a template:

<?xml version=“1.0” encoding=“utf-8”?>
<WidgetTemplate

id=“@+id/simple_light_template”
layout=“@layout/widget_simple_light” >
<bind-target id=“@+id/icon”

view=“@id/light2”
method=“setImageResource”
input_type=“int”/>

<bind-target id=“@+id/light_name”

view=“@id/name”
method=“setText”
input_type=“java.lang.CharSequence”/>

<bind-target id=“@+id/light_switch”

view=“@id/switch2”
method=“setCheckedSilent”
input_type=“boolean”/>

<bind-target id=“@+id/switch_onchange_listener”

view=“@id/switch2”
method=“setOnCheckedChangeListener”
input_type=“robot.widget.CompoundButton$OnCheckedChangeListener”/>

</WidgetTemplate>

Here, the code within the template contains the template ID “@+id/simple_light_template” and contains layout information to bind with a widget.

A template may be requested from an application server that contains templates that are designated for the hub application. The user device and/or hub application may provide the application server with the template ID extracted from a widget corresponding to a physical device. In response, the application server may provide the requested template. The widget then may be rendered at the user device using the template. Alternatively, a template manager may load pre-compiled templates supported by the hub application when the hub application is activated. Accordingly, when a new physical device is detected and a widget corresponding to the physical device is received, the template manager may be accessed by the hub application to retrieve a template identified by a widget. Subsequently, the widget may be compiled by binding to values received from the respective template. The widget may be compiled in any applicable manner and the complied widget may result in the rendered interface to be rendered via the hub application.

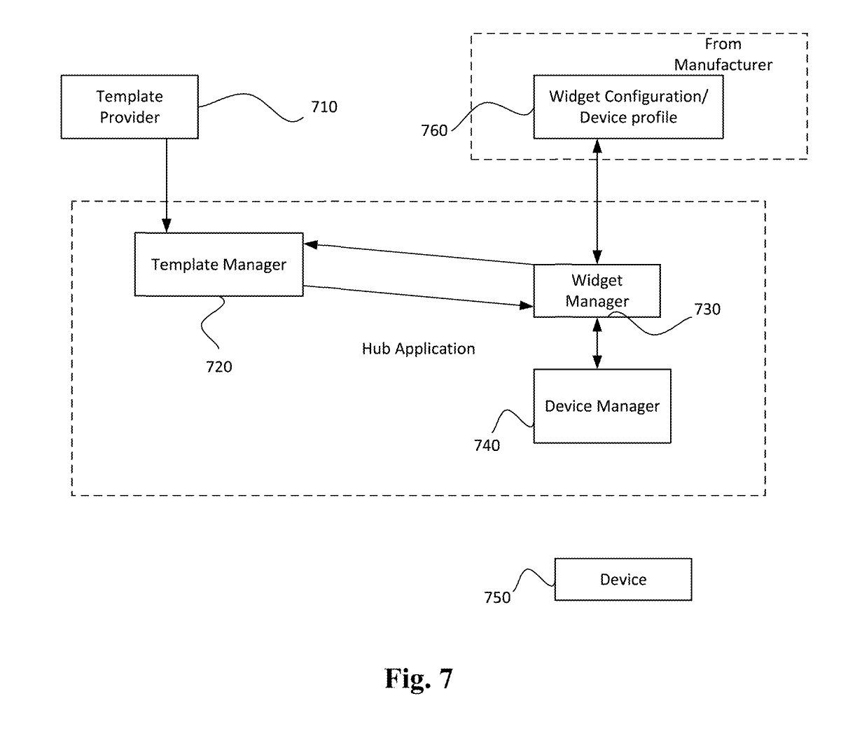

As an illustrative example of the disclosed subject matter, as shown in FIG. 7, a template provider 710 may provide a hub application's template manager 720 with available templates upon activation of the hub application. The hub application may associate with or may act as a communication component such that it communicates with one or more of a template provider, physical device, and/or manufacturer/3^{rd} party server. The hub application may store the templates in a cache such that the cached templates are subsequently available to bind with widgets without communicating with the template provider 710. The device 750 may activate for the first time and, based on the activation, a device manager 740 may detect the presence of the device 750, according to the techniques disclosed herein. The device manager 740 may receive physical device information such as a model ID and/or vendor ID and provide the information to the widget manager 730. The widget manager 730 may communicate with a widget configuration/device profile component 760 and the widget configuration/device profile component 760 may provide the widget manager 730 with a widget corresponding to the model ID and/or vendor ID. The widget manager may extract template information (e.g., template ID) from the provided widget and communicate with the template manager 720 to receive the corresponding template. The template may subsequently be used to compile the widget such that a user accessing the hub application is provided an interface for the newly activated physical device via the hub application. Notably, the widget provided by the widget configuration/device profile component 760 may be provided by the manufacturer of the physical device and, thus, may be customized for the physical device.

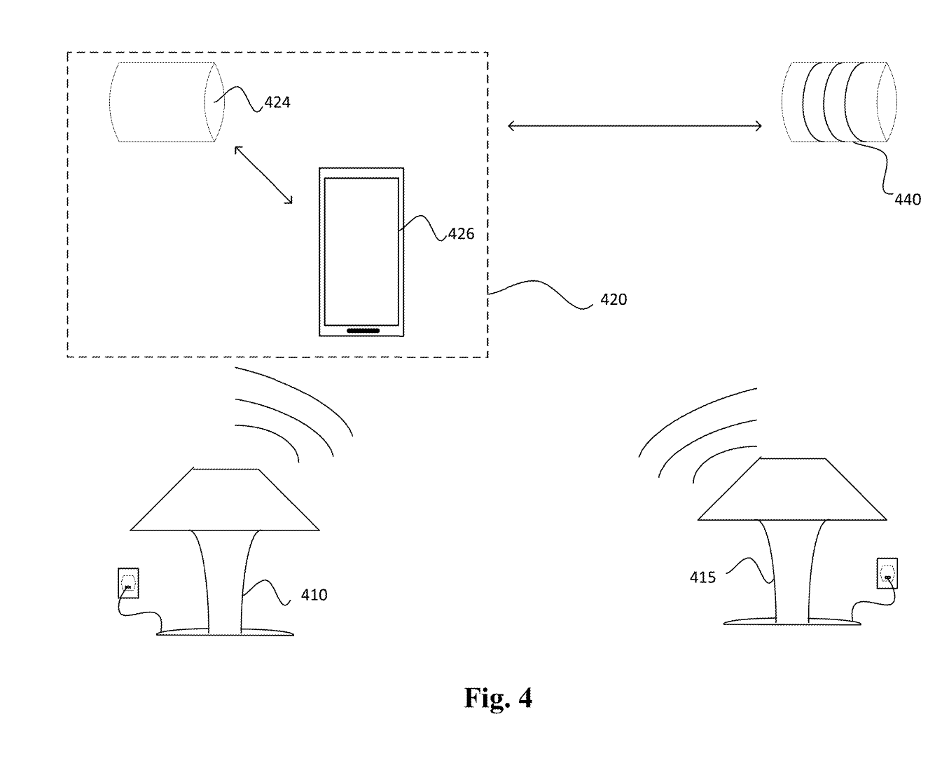

As another example of an implementation of the disclosed subject matter, as shown in FIG. 4, a first lamp 410 may located in a room and may be controlled via a hub application running on user device 426. Subsequently, an additional lamp 415 may be added to the room and, upon activation of the second lamp 415, the user device 426 may receive identifying information from lamp 415. The user device 426 may provide the information received from the second lamp 415 to a third party manufacturer server 440 and the third party manufacturer server 440 may provide the user device with a corresponding widget. The mobile device may communicate with a template server 424 either at initiation or after receiving a widget from the manufacturer server 440. The template server may provide the corresponding template and a widget configuration file may be compiled based on the widget and the template. Notably, the widget may be bound to values from an hub application approved template such that the compiled interface is configured by the manufacture via the widget and the template contains hub application approved resources, allowing the hub application to maintain consistency across multiple interfaces corresponding to multiple physical objects. Instructions corresponding to operation of a physical device may be received via the compiled interface and the physical device may be operated based on the instructions. As an example, a user may select a “turn light lamp 1 on” via the light lamp 1's interface within the hub application. Accordingly, light lamp 1 may turn on based on the instruction.

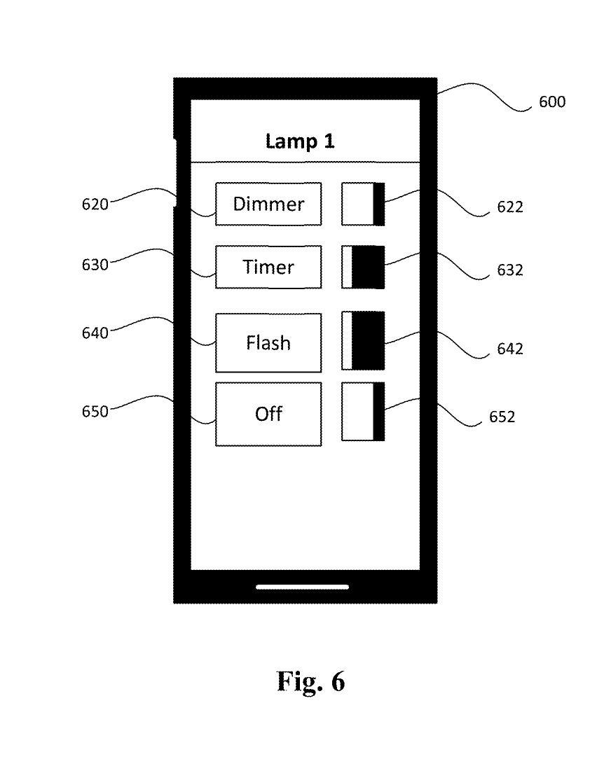

As an illustrative example of a customized user interface corresponding to a physical device, as shown in FIG. 6, a hub application may contain a page for a Lamp 1. The widget used to compile the page may contain information such as the interface requiring four buttons: dimmer 620, timer 630, flash 640, and an off button 650. The template corresponding to the compiled interface may contain the actual icons for the buttons to be displayed as well as on/off switches 622, 632, 642, and 652 corresponding to the buttons. Notably, the widget may contain information regarding the required resources for control of the physical device and the template may contain approved resources for compiling a hub application.

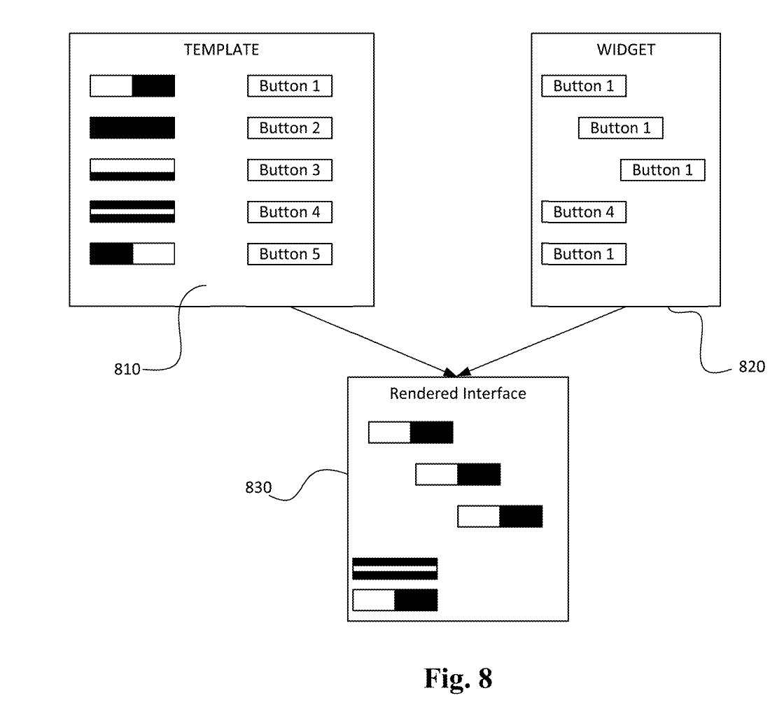

FIG. 8 shows an illustrative example of how a widget and template are compiled together to generate a rendered interface. As shown, a template 810 may contain a plurality of items (e.g., buttons) that are approved for a hub application. A widget 820 may contain positioning information as well as a requested button ID such that when the template 810 is paired with the widget 820 to compile the widget 820, the resulting rendered interface 830 contains the buttons called for in the widget 820 at the locations defined in the widget 820. More specifically, the widget 820 requests button 1 in the top left position. Accordingly, the rendered interface contains the button 1 (as provided by the template 810) in the top left position, as defined in widget 820. Essentially, the template may contain components that help maintain a consistent look and feel of the rendered hub application for different physical devices, while the individual controls within the hub application can be custom provided via widgets from the manufacturer or a third party.

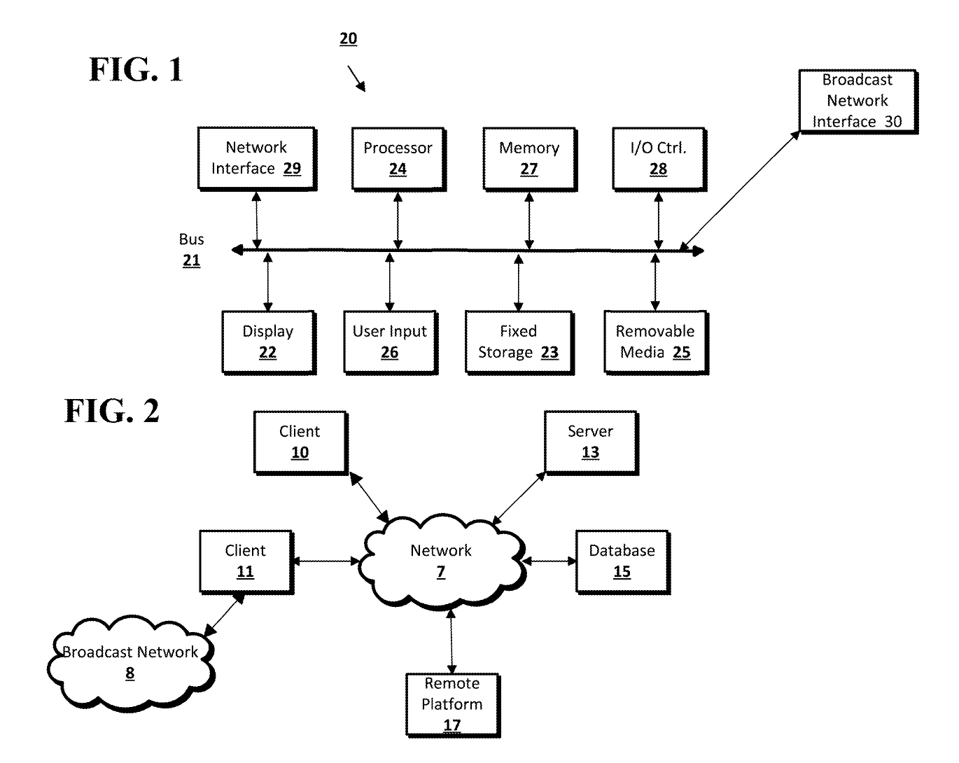

Implementations of the presently disclosed subject matter may be implemented in and used with a variety of component and network architectures. FIG. 1 is an example computer 20 suitable for implementing implementations of the presently disclosed subject matter. The compute may be associated with a user device that is configured to run applications such as physical device applications. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection, WiFi, Zigbee™, Z-Wave™, or the like. For example, the network interface 29 may allow the computer to communicate with other computers via one or more local, wide-area, or other networks, as shown in FIG. 2. A broadcast network interface 30 may receive a broadcast transmission. The broadcast transmission may be provided via a 1 or 2-way satellite modem connected via any applicable connection such as via a coax to satellite dish/LNB.

Many other devices or components (not shown) may be connected in a similar manner (e.g., caches, servers, appliances, lighting, electric vehicle chargers, pumps, document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an implementation of the disclosed subject matter. One or more clients 10, 11, such as caches, local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15. Additionally, one or more clients 10, 11 also may receive communication from a Broadcast Network component 8. The Broadcast Network Component 8 may include a satellite configured to transmit a broadcast signal to the one or more clients 10, 11.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
detecting the presence of a first physical device;
obtaining a device identification corresponding to the detected first physical device;
receiving a widget associated with the detected first physical device based on the extracted device identification, the widget comprising template information; and
receiving a template based on the template information comprised within the widget.

2. The method of claim 1, further comprising:
binding the values from the template with the widget; and
compiling the widget based on the bound values from the template.

3. The method of claim 1, further comprising:
generating a user interface based upon the template;
receiving an instruction from a user via the user interface; and
controlling an operation of the physical device based upon the instruction.

4. The method of claim 2, further comprising rendering the compiled widget.

5. The method of claim 4, wherein the compiled widget is rendered in a hub application.

6. The method of claim 5, wherein two or more devices are controlled via the hub application.

7. The method of claim 1, wherein the device information is at least one selected from the group consisting of: a vendor identification and a model identification.

8. The method of claim 1, wherein detecting the presence of the first physical device is conducted by a wireless connection with the first physical device.

9. The method of claim 1, wherein communication with the detected first physical device is conducted via a connection selected from the group consisting of: a Bluetooth™ connection, a Wi-Fi connection, a radio frequency connection, an infra-red connection, and a near field communication connection.

10. The method of claim 1, wherein the widget is stored at a third party server.

11. The method of claim 1, further comprising receiving the template from a central server.

12. The method of claim 2, wherein the template provides a graphical component to be used when compiling the widget.

13. The method of claim 1, wherein the template provides display instructions.

14. The method of claim 1, wherein the template is a hub application approved template.

15. The method of claim 1, wherein detecting the presence of a first physical device occurs in response to the first physical device being first powered on.

16. A system comprising:
a processor configured to:
detect the presence of a first physical device; and
receive a device identification corresponding to the detected first physical device;
receive a widget associated with the detected first physical device based on the extracted device identification, the widget comprising template information;
receive a template based on the template information comprised within the widget; and
a user interface configured to:
present the widget configured with the template information to a user; and
receive an instruction indicating a command for controlling operation of the first physical device from the user.

17. The system of claim 16, further configured to generate a user interface based on the widget.

18. The system of claim 17 wherein the user interface is configured to receive a receive an instruction from a user via the user interface; and
wherein the communication component is further configured to control an operation of the physical device based upon the instruction.

19. The system of claim 16, further configured to:
bind the values from the template with the widget; and
compile the widget based on the bound values from the template.

20. The system of claim 19, further configured to render the compiled widget.

21. The system of claim 20, wherein the compiled widget is rendered in a hub application.

22. The system of claim 21, wherein two or more devices are controlled via the hub application.

23. The system of claim 16, wherein the device information is at least one selected from the group consisting of: a vendor identification and a model identification.

24. The system of claim 16, wherein detecting the presence of the first physical device is conducted by a wireless connection with the first physical device.

25. The system of claim 16, wherein communication with the detected first physical device is conducted via a connection selected from the group consisting of: a Bluetooth™ connection, a Wi-Fi connection, a radio frequency connection, an infra-red connection, and a near field communication connection.

26. The system of claim 16, wherein the widget is stored at a third party server.

27. The system of claim 16, further configured to provide the template from a central server.

28. The system of claim 19, wherein the template provides a graphical component to be bound with the widget.

29. The system of claim 16, wherein the template provides display instructions.

30. The system of claim 16, wherein the template is a hub application approved template.

31. The system of claim 16, wherein detecting the presence of a first physical device occurs when the first physical device is first powered on.
